(19) United States
(12) Patent Application Publication
(10) Pub. No.: US 2022/0398244 A1
(43) Pub. Date: Dec. 15, 2022

(54) QUERY METHOD AND DEVICE AND STORAGE MEDIUM

(71) Applicant: BEIJING BAIDU NETCOM SCIENCE TECHNOLOGY CO., LTD., Beijing (CN)

(72) Inventors: Yanyan LI, Beijing (CN); Haoyi XIONG, Beijing (CN); Jiang BIAN, Beijing (CN); Zheng GONG, Beijing (CN); Ruyue MA, Beijing (CN); Dejing DOU, Beijing (CN)

(21) Appl. No.: 17/890,366

(22) Filed: Aug. 18, 2022

(30) Foreign Application Priority Data
Sep. 23, 2021 (CN) 202111117312.7

(51) Int. Cl. G06F 16/242; G06F 16/28

(52) U.S. Cl. CPC G06F 16/2428; G06F 16/287

(57) ABSTRACT

A query method is provided and includes: acquiring association records, in which the association record is configured to indicate an execution area, execution time and user attribute data of an execution user, of a behavior; splitting the association record into behavior records based on attribute items included in the user attribute data of the association record, in which the behavior record is configured to indicate a mapping relationship between at least one of the attribute items and the execution area-the execution time; grouping the behavior records to determine behavior statistics information of each group; in which behavior records having the same attribute item, the same execution area and the same execution time belong to the same group; and displaying behavior statistics information of a target group in response to a query operation.

### CROSS-REFERENCE TO RELATED APPLICATION

This application claims priority to Chinese Patent Application No. 202111117312.7, filed on Sep. 23, 2021, the entire content of which is incorporated herein by reference.

### TECHNICAL FIELD

The disclosure relates to the field of computer technologies, and particularly to, the field of big data, information stream and smart cities.

### BACKGROUND

In recent years, with the rapid development and wide application of devices related to sensor networks, mobile Internet, radio frequency identification and global positioning systems, massive data including temporal dimension and spatial dimension are generated. In the related art, research and processing for temporal and spatial data may focus on a certain service requirement, to output a service result, with the single service and low response efficiency.

### SUMMARY

According to a first aspect of the disclosure, a query method is provided and includes: acquiring association records, in which the association record is configured to indicate an execution area, execution time and user attribute data of an execution user, of a behavior; splitting the association record into behavior records based on attribute items included in the user attribute data of the association record, in which the behavior record is configured to indicate a mapping relationship between at least one of the attribute items and the execution area-the execution time; grouping the behavior records to determine behavior statistics information of each group; in which behavior records having the same attribute item, the same execution area and the same execution time belong to the same group; and displaying behavior statistics information of a target group in response to a query operation.

According to a second aspect of the disclosure, an electronic device is provided and includes: at least one processor; and a memory communicatively connected to the at least one processor; in which the memory is stored with instructions executable by the at least one processor, and the instructions are performed by the at least one processor, to cause the at least one processor to perform the method as described in the first aspect.

According to a third aspect of the disclosure, a non-transitory computer readable storage medium stored with computer instructions is provided. The computer instructions are configured to cause a computer to perform the method as described in the first aspect.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure.

FIG. 1 is a diagram illustrating a query method according to some embodiments of the disclosure.

FIG. 2 is a flowchart illustrating another query method according to some embodiments of the disclosure.

FIG. 3 is a query interface according to some embodiments of the disclosure.

FIG. 4 is a diagram illustrating a query apparatus according to some embodiments of the disclosure.

FIG. 5 is a block diagram illustrating an electronic device configured to achieve a query method in some embodiments of the disclosure.

### DETAILED DESCRIPTION

Embodiments of the disclosure are described as below with reference to the accompanying drawings, which include various details of embodiments of the disclosure to facilitate understanding, and should be considered as merely exemplary. Therefore, those skilled in the art should realize that various changes and modifications may be made to some embodiments described herein without departing from the scope and spirit of the disclosure. Similarly, for clarity and conciseness, descriptions of well-known functions and structures are omitted in the following descriptions.

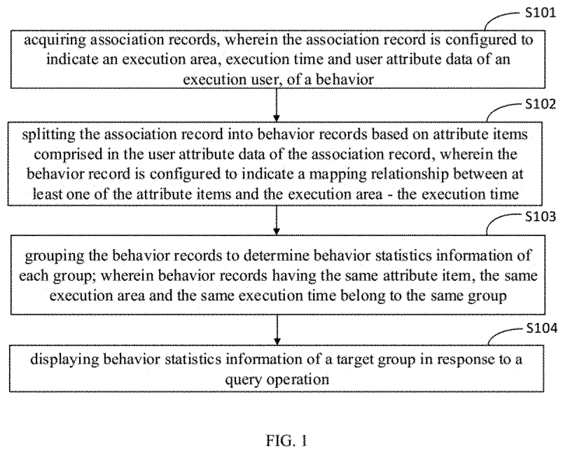

A query method is provided in some embodiments of the disclosure. Referring to a flowchart of the query method as illustrated in FIG. 1, the method may be performed by an electronic device with data processing abilities, in which the electronic device is not limited herein. The method includes actions in the following blocks S101 to S104.

It should be noted that, acquisition, storage and application of user behavior data and user attribute data involved in the technical solution of the disclosure comply with relevant laws and regulations, and do not violate public order and good customs. For example, it may be acquired from a public data set or acquired from a data set licensed by a user.

At S101, association records are acquired, in which the association record is configured to indicate an execution area, execution time and user attribute data of an execution user, of a behavior.

The association record refers to a record associating user behavior data with user attribute data from the same execution user, in which the user behavior data is configured to indicate the execution user, the execution area and the execution time of the behavior and the user attribute data is attribute(s) of the execution user itself.

Optionally, the execution area may be regional geographic coordinates or administrative regions at different administrative division levels. The execution time may be a date or xx hour xx minute, and the granularity of the execution time may be adjusted based on the service requirement.

It may be understood that, in some embodiments, different behaviors of the same execution user may have different execution areas and execution time, and thus there may be different association records, that is, the same execution user may have association records, and each piece of behavior data corresponds to one association record.

Optionally, the user attribute data of the execution user is data of the attribute(s) of the execution user itself, including attribute items, such as population type, gender, age, and native place of the execution user.

It may be understood that, the attribute items may be correspondingly configured and changed based on different service research requirements.

It needs to be noted that, the user behavior data and the user attribute data may be acquired in public, legal and compliant manners.

At block S102, the association record is splitted into behavior records based on attribute items included in the user attribute data of the association record, in which the behavior record is configured to indicate a mapping relationship between at least one of the attribute items and the execution area-the execution time.

That is, each association record is splitted into behavior records based on the attribute items in the user attribute data, in which each behavior record is configured to indicate the mapping relationship between at least one of the attribute items and the execution area-the execution time.

It needs to be noted that, the behavior record represents a person having a certain attribute item in a certain execution area at certain execution time, that is, indicates the mapping relationship between at least one attribute item and the execution area-the execution time.

At block S103, the behavior records are grouped to determine behavior statistics information of each group; in which behavior records having the same attribute item, the same execution area and the same execution time belong to the same group.

The behavior statistics information refers to statistics results of behavior records in each group after grouping based on a statistical algorithm.

Optionally, the statistical algorithm may be at least one of summation, averaging, median and mode.

It may be understood that, behavior records having the same attribute item, the same execution area and the same execution time belong to the same group. Therefore, behavior statistics information of each group is statistics information having the attribute item in the execution area at the execution time.

In addition, it should be noted that, since the meanings of attribute items are different, different statistical algorithms are adopted for statistics for different attribute items, that is, statistical algorithms obtaining behavior statistics information may be different for different groups.

At block S104, behavior statistics information of a target group is displayed in response to a query operation.

A target group may be a target group corresponding to a query condition of the query operation.

Optionally, a query condition is acquired in response to the query operation; the query condition includes a target area, target time and a target attribute; at least one target attribute item associated with the target attribute is queried; the matched target group is determined from the groups based on the at least one target attribute item, the target time and the target area; and the behavior statistics information of the target area is displayed.

In some implementations, a user performs the query operation by inputting the query condition or selecting at least one of query conditions in the options. For example, the user selects attribute information and inputs area information and time information for query.

In some embodiments of the disclosure, the query method may perform data storage, processing and query by an online analysis processing (OLAP) system, for example, a Doris system, to further improve the response efficiency of query.

In the query method provided in some embodiments of the disclosure, the query apparatus and the storage medium provided in some embodiments of the disclosure, the association records are acquired, in which each association record is configured to indicate execution areas, execution time and user attribute data of execution users, of various behaviors; each association record is splitted into behavior records based on the attribute items included in the user attribute data of the association record, in which the behavior record is configured to indicate a mapping relationship between at least one of the attribute items and the execution area-the execution time; the behavior records are grouped to determine behavior statistics information of each group; the behavior records having the same attribute item, the same execution area and the same execution time belong to the same group; and the behavior statistics information of the target group is displayed in response to the query operation. Research on service characteristics may be rapidly and conveniently performed in the temporal dimension and the spatial dimension, which effectively enhances the response efficiency of query.

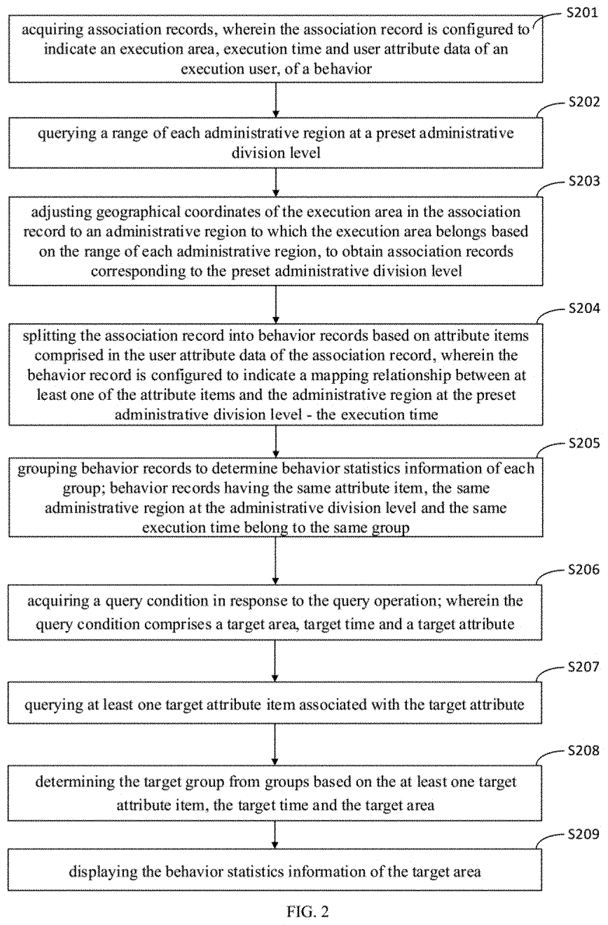

Referring to a flowchart of another query method as illustrated in FIG. 2, it schematically describes a flow of a method for performing query, and includes actions in the following blocks S201 to S209.

It should be noted that, acquisition, storage and application of user behavior data and attribute data involved in the technical solution of the disclosure comply with relevant laws and regulations, and do not violate public order and good customs. For example, it may be acquired from a public data set or acquired from a data set licensed by the user.

At S201, association records are acquired, in which the association record is configured to indicate an execution area, execution time and user attribute data of an execution user, of a behavior.

Optionally, pieces of user behavior data and pieces of user attribute data are acquired from a data source, in which each piece of user behavior data is configured to indicate an execution user, an execution area and execution time, corresponding to a behavior; and for each piece of user behavior data, the piece of user attribute data of the execution user is associated with the corresponding execution area and the execution time to obtain the association record.

That is, for each piece of user behavior data, the user attribute data of the execution user is associated with the corresponding execution area and execution time based on the execution user. The same execution user may have pieces of user behavior data, that is, may have pieces of association records.

The user attribute data of the execution user is data that may indicate the attribute(s) of the execution user itself, including a plurality of attribute items, for example, population type, gender, age, and native place of the execution user.

The execution time may be a date, and also specifically may be an hour, and the granularity of the execution time may be adjusted based on the service requirement.

It should be noted that, acquisition, storage and application of user behavior data and attribute data comply with relevant laws and regulations, and do not violate public order and good customs. The data source is a public data source or a data source licensed by a user.

Optionally, the data acquired from the data source may be transmitted by kafaka or other distributed log system to a stream processing system for processing to obtain pieces of user behavior data.

At block S202, a range of each administrative region at a preset administrative division level is queried.

The administrative division levels may include province, city, district/county, subdistrict/township and park. For example, Beijing (province), Beijing (city), Haidian District (district/county), Xibeiwang Town (subdistrict/township), Baidu Technology Park (park).

Querying the range of each administrative region at the preset administrative division level refers to querying a range of geographic coordinates included in a certain administrative region at a certain administrative division level, that is, querying a polygon range representing a certain administrative region.

At block S203, geographical coordinates of the execution area in the association record are adjusted to an administrative region to which the execution area belongs based on the range of each administrative region, to obtain association records corresponding to the preset administrative division level.

By determining the administrative region to which the geographical coordinates of the execution area in the association record belong based on the queried range of the administrative region at each administrative division level, the geographical coordinates of the execution area in the association record are adjusted to the administrative region corresponding to each administrative division level, to obtain association records corresponding to the preset administrative division level.

That is, for example, geographic coordinates of the execution area in the user behavior data of the certain association record of the certain execution user is located in Baidu Technology Park, and the association record includes the execution area, execution time, and user attribute data of the execution user. After block S202, the range of each administrative region at the administrative division level is queried, and by determining the inclusion relationship between the coordinates and the range of the administrative region, it may be determined that the geographical coordinates of the execution area belong to Baidu Technology Park, and also belong to Xibeiwang Town (subdistrict/township), Haidian District (district/county), Beijing (city) and Beijing (province). That is, the association record becomes five association records, and the execution areas of the five association records are respectively Baidu Technology Park (Park), Xibeiwang Town (subdistrict/township), Haidian District (district/county), Beijing (city) and Beijing (province), and the execution time and the user attribute data of the execution user, of the five association records, are the same.

At block S204, the association record is splitted into behavior records based on attribute items included in the user attribute data of the association record, in which the behavior record is configured to indicate a mapping relationship between at least one of the attribute items and the administrative region at the preset administrative division level-the execution time.

That is, the association record is splitted into behavior records based on the attribute items in the user attribute data, in which the behavior record is configured to indicate a mapping relationship between at least one of the attribute items and the execution area-the execution time.

It needs to be noted that, the behavior record represents a person having a certain attribute item in a certain execution area at certain execution time, that is, indicates a mapping relationship between at least one attribute item with and the execution area-the execution time.

The execution area is the administrative region at the preset administrative division level.

For example, in the association record before adjusting the execution area at block S203, the user attribute data of the execution user includes attribute items: population type, gender, and native place. When the execution area of the association record is adjusted, the association record becomes five association records, and the execution time and the user attribute data of the five association records are the same. Then, block S204 is performed. The association record is splitted into behavior records based on attribute items included in the user attribute data of the association record, in which the first behavior record is configured to indicate a mapping relationship between attribute items of employed population (population type) and male (gender), and Baidu Science Park (park)-the execution time, that is, indicate that there is a male employed population in Baidu Science Park (park) at the execution time; the second behavior record is configured to indicate a mapping relationship between attribute items of employed population (population type) and Beijing (native place), and Baidu Science Park (park)-the execution time, that is, indicate that there is an employed population whose native place is Beijing in Baidu Science Park at the execution time; the third behavior record indicate a mapping relationship between attribute items of employed population (population type) and male (gender), and Xibeiwang Town (subdistrict/township)-the execution time, that is, indicate that there is a male employed population in Xibeiwang Town (subdistrict/township) at the execution time, . . . and so on, five association records are splitted into ten behavior records, and each behavior record indicates the mapping relationship between at least one attribute item and the execution area at the preset administrative division level-the execution time.

At block S205, behavior records are grouped to determine behavior statistics information of each group; behavior records having the same attribute item, the same administrative region at the administrative division level and the same execution time belong to the same group.

It may be understood that, the behavior records in the same group after grouping have the same attribute item, the same execution area at the administrative division level and the same execution time.

For example, a certain group is Baidu Science Park (park), xx year xx month xx date, employed population (population type) and Beijing (native place), behavior records in this group are Baidu Science Park (park), xx year xx month xx date, employed population (population type) and Beijing (native place).

Further, the statistics is performed on the behaviors of the group to obtain behavior statistics information of the group.

Optionally, statistics may be calculation based on a calculation algorithm, and optionally, the statistical algorithm may be at least one of summation, averaging, median and mode.

It may be understood that, since the meanings of attribute items themselves are different, different statistical algorithms are adopted for statistics for different attribute items, that is, statistical algorithms obtaining behavior statistics information may be different for different groups.

At block S206, a query condition is acquired in response to the query operation; the query condition includes a target area, target time and a target attribute.

In some implementations, the user performs the query operation by inputting the query condition or selecting at least one of query conditions in the options. For example, the user selects attribute information and inputs area information and time information for query.

The target time may be granularity of execution time or a time range greater than the granularity of execution time. For example, if the granularity of execution time is a date, the target time may be a certain date, and also may be a period of time from a start date to an end date.

At block S207, at least one target attribute item associated with the target attribute is queried.

For example, when the target attribute is a native place, the at least one target attribute item associated with the target attribute queried is: Beijing, Hebei, Shandong, Shanxi . . . ; when the target attribute is a gender, the at least one target attribute item associated with the target attribute queried is: male, female; when the target attribute is a population type, the at least one target attribute item associated with the target attribute queried is: total population, resident population, migrant population, employed population, unemployed population, etc.

At block S208, the matched target group is determined from the groups based on the at least one target attribute item, the target time and the target area.

For example, when the target area is Haidian District, the target time is xx year xx month xx date and the target attribute is native place, the target groups matched determined from the groups are a first group: Haidian District (district/county), xx date xx month xx year, Beijing (native place), a second group: Haidian District (district/county), xx date xx month xx year, Hebei (native place), a third group: Haidian District (district/county), xx date xx month xx year, Shandong (native place) . . . and so on. The above groups constitute a target group.

At block S209, behavior statistics information of the target area is displayed.

Statistics information refers to information obtained by counting behavior statistics information of each group in the target group.

Optionally, a percentage of behavior statistics information in each group, a specific value of behavior statistics information in each group, ranking of behavior statistics information in each group, a schematic diagram of behavior statistics information in each group, etc. may be displayed based on the service requirement.

In some embodiments of the disclosure, the query method may perform data storage, processing and query by an online analysis processing (OLAP) system, for example, a Doris system, to further improve the response efficiency of query.

In the above method provided in some embodiments of the disclosure, the association records are acquired, in which each association record is configured to indicate execution areas, execution time and user attribute data of execution users, of various behaviors; a range of each administrative region at a preset administrative division level is queried, and geographical coordinates of the execution area in the association record are adjusted to an administrative region to which the execution area belongs based on the range of each administrative region, to obtain association records corresponding to the preset administrative division level; the association record is splitted into behavior records based on attribute items included in the user attribute data of the association record, in which the behavior record is configured to indicate a mapping relationship between at least one of the attribute items and the administrative region at the preset administrative division level-the execution time; behavior records are grouped to determine behavior statistics information of each group; behavior records having the same attribute item, the same administrative region at the administrative division level and the same execution time belong to the same group; and a query condition is acquired in response to a query operation; the query condition includes a target area, target time and a target attribute; at least one target attribute item associated with the target attribute is queried; the target group matched is determined from the groups based on the at least one target attribute item, the target time and the target area; and the behavior statistics information of the target area is displayed. Research on service characteristics may be rapidly and conveniently performed in the temporal dimension and the spatial dimension, which effectively enhances the response efficiency of query.

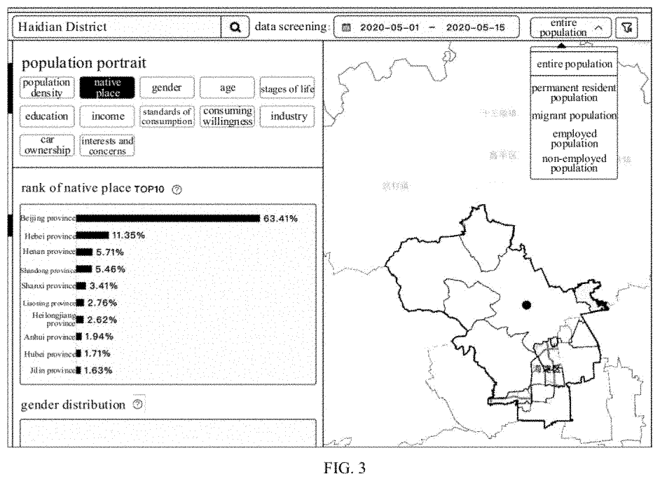

In order to describe the query method in the above embodiments more clearly and intuitively, it may refer to a query interface as illustrated in FIG. 3.

As illustrated in FIG. 3, the target area and the target time may be input and target attributes (population type) and (native place) may be selected for query, to display behavior statistics information of the target group corresponding to the query condition.

It may be understood that, the target groups corresponding to the query condition are: a first group: Haidian District (district/county), May 1, 2020, resident population (population type), Beijing (native place); a second group: Haidian District (district/county), May 1, 2020, migrant population (population type), Beijing (native place); a third group: Haidian District (district/county), May 1, 2020, employed population (population type), Beijing (native place); a fourth group: Haidian District (district/county), May 1, 2020, unemployed population (population type), Beijing (native place); a fifth group: Haidian District (district/county), May 2, 2020, resident population (population type), Beijing (native place), . . . and so on.

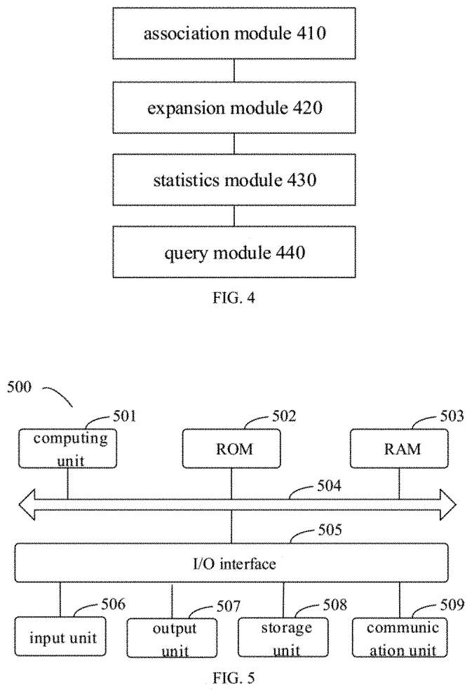

A query apparatus corresponding to the above query method is further provided in some embodiments of the disclosure. Referring to the block diagram of a structure of a query apparatus as illustrated in FIG. 4, the apparatus mainly includes an association module 410, an expansion module 420, a statistics module 430 and a query module 440.

The association module 410 is configured to acquire association records, in which the association record is configured to indicate an execution area, execution time and user attribute data of an execution user, of a behavior.

The expansion module 420 is configured to split the association record into behavior records based on attribute items comprised in the user attribute data of the association record, in which the behavior record is configured to indicate a mapping relationship between at least one of the attribute items and the execution area-the execution time.

The statistics module 430 is configured to group the behavior records to determine behavior statistics information of each group; in which behavior records having the same attribute item, the same execution area and the same execution time belong to the same group.

The query module 440 is configured to display behavior statistics information of a target group in response to a query operation.

In some implementations, the query module 440 is specifically configured to: acquire a query condition in response to the query operation; in which the query condition includes a target area, target time and a target attribute; query at least one target attribute item associated with the target attribute; determine the target group from groups based on the at least one target attribute item, the target time and the target area; and display the behavior statistics information of the target area.

In some implementations, the apparatus further includes an adjusting module. The adjusting module is configured to query a range of each administrative region at a preset administrative division level; and adjust geographical coordinates of the execution area in the association record to an administrative region to which the execution area belongs based on the range of each administrative region, to obtain association records corresponding to the preset administrative division level.

In some implementations, the statistics module 430 is specifically configured to: group behavior records corresponding to the same preset administrative division level to determine behavior statistics information of each group in response to multiple preset administrative division levels.

In some implementations, the association module 410 is specifically configured to: acquire pieces of user behavior data and pieces of user attribute data from a data source, wherein, wherein each piece of user behavior data is configured to indicate an execution user, an execution area and execution time, of a behavior; and for each piece of user behavior data, associate the piece of user attribute data of the execution user with the corresponding execution area and execution time to obtain the association record.

In the query apparatus provided in some embodiments of the disclosure, the query apparatus and the storage medium provided in some embodiments of the disclosure, the association records are acquired, in which each association record is configured to indicate execution areas, execution time and user attribute data of execution users, of various behaviors; each association record is splitted into behavior records based on the attribute items included in the user attribute data of the association record, in which the behavior record is configured to indicate a mapping relationship between at least one of the attribute items and the execution area-the execution time; the behavior records are grouped to determine behavior statistics information of each group; the behavior records having the same attribute item, the same execution area and the same execution time belong to the same group; and the behavior statistics information of the target group is displayed in response to the query operation. Research on service characteristics may be rapidly and conveniently performed in the temporal dimension and the spatial dimension, which effectively enhances the response efficiency of query.

According to some embodiments of the disclosure, an electronic device, a readable storage medium and a computer program product are further provided in the disclosure.

First, an electronic device is provided in some embodiments of the disclosure. The device includes: at least one processor; and a memory communicatively connected to the at least one processor and stored with instructions executable by the at least one processor; in which the instructions are performed by the at least one processor, to cause the at least one processor to perform any of the above methods.

A computer program product including a computer program is provided in some embodiments of the disclosure, the computer program being configured to achieve any of the above methods when performed by a processor.

FIG. 5 illustrates a block diagram of an example electronic device 500 configured to implement some embodiments of the disclosure. Electronic devices are intended to represent various types of digital computers, such as laptop computers, desktop computers, workstations, personal digital assistants, servers, blade servers, mainframe computers, and other suitable computers. Electronic devices may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 5, a device 500 includes a computing unit 501, configured to execute various appropriate actions and processes according to a computer program stored in a read-only memory (ROM) 502 or loaded from a storage unit 508 to a random access memory (RAM) 503. In a RAM 503, various programs and data required for a device 500 may be stored. The computing unit 501, the ROM 502, and the RAM 503 are connected to each other through a bus 504. An input/output (I/O) interface 505 is also connected to a bus 504.

Several components in the device 500 are connected to the I/O interface 505, and include: an input unit 506, for example, a keyboard, a mouse, etc.; an output unit 507, for example, various types of displays, speakers, etc.; a storage unit 508, for example, a magnetic disk, an optical disk, etc.; and a communication unit 509, for example, a network card, a modem, a wireless communication transceiver, etc. The communication unit 509 allows the device 500 to exchange information/data with other devices over a computer network such as the Internet and/or various telecommunication networks.

The computing unit 501 may be various types of general and/or dedicated processing components with processing and computing ability. Some examples of a computing unit 501 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 501 performs various methods and processings as described above, for example, a query method. For example, in some embodiments, the query method may be further achieved as a computer software program, which is physically contained in a machine readable medium, such as a storage unit 508. In some embodiments, a part or all of the computer program may be loaded and/or installed on the device 500 through a ROM 502 and/or a communication unit 509. When the computer program is loaded on a RAM 503 and executed by a computing unit 501, one or more blocks in the method for map query as described above may be performed. Alternatively, in other embodiments, a computing unit 501 may be configured to perform a query method in other appropriate ways (for example, by virtue of a firmware).

Various implementation modes of the systems and technologies described above may be achieved in a digital electronic circuit system, a field programmable gate array (FPGA), an application-specific integrated circuit (ASIC), an application specific standard product (ASSP), a system-on-chip (SOC) system, a complex programmable logic device, a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the disclosure may be written with one or any combination of a plurality of programming languages. The programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a speech input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), a blockchain network, and an internet.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, and further may be a server of a distributed system, or a server in combination with a blockchain.

It should be understood that, various forms of procedures shown above may be configured to reorder, add or delete blocks. For example, blocks described in the disclosure may be executed in parallel, sequentially, or in different orders, as long as the desired result of the technical solution disclosed in the disclosure may be achieved, which will not be limited herein.

What is claimed is:

1. A query method, comprising:
acquiring association records, wherein the association record is configured to indicate an execution area, execution time and user attribute data of an execution user, of a behavior;
splitting the association record into behavior records based on attribute items comprised in the user attribute data of the association record, wherein the behavior record is configured to indicate a mapping relationship between at least one of the attribute items and the execution area-the execution time;
grouping the behavior records to determine behavior statistics information of each group; wherein behavior records having the same attribute item, the same execution area and the same execution time belong to the same group; and
displaying behavior statistics information of a target group in response to a query operation.

2. The method of claim 1, wherein, displaying the behavior statistics information of the target group in response to the query operation, comprises:
acquiring a query condition in response to the query operation; wherein the query condition comprises a target area, target time and a target attribute;
querying at least one target attribute item associated with the target attribute;
determining the target group from groups based on the at least one target attribute item, the target time and the target area; and
displaying the behavior statistics information of the target area.

3. The method of claim 1, further comprising:
querying a range of each administrative region at a preset administrative division level; and
adjusting geographical coordinates of the execution area in the association record to an administrative region to which the execution area belongs based on the range of each administrative region, to obtain association records corresponding to the preset administrative division level.

4. The method of claim 3, wherein, grouping the behavior records to determine the behavior statistics information of each group, comprises:
grouping behavior records corresponding to the same preset administrative division level to determine behavior statistics information of each group in response to multiple preset administrative division levels.

5. The method of claim 1, wherein, acquiring the association records, comprising:
acquiring pieces of user behavior data and pieces of user attribute data from a data source, wherein, wherein each piece of user behavior data is configured to indicate an execution user, an execution area and execution time, of a behavior; and
for each piece of user behavior data, associating the piece of user attribute data of the execution user with the corresponding execution area and execution time to obtain the association record.

6. An electronic device, comprising:
a processor; and
a memory communicatively connected to the processor and for storing instructions executable by the processor; wherein,
the processor is configured to:
acquire association records, wherein the association record is configured to indicate an execution area, execution time and user attribute data of an execution user, of a behavior;
split the association record into behavior records based on attribute items comprised in the user attribute data of the association record, wherein the behavior record is configured to indicate a mapping relationship between at least one of the attribute items and the execution area-the execution time;
group the behavior records to determine behavior statistics information of each group; wherein behavior records having the same attribute item, the same execution area and the same execution time belong to the same group; and
display behavior statistics information of a target group in response to a query operation.

7. The device of claim 6, wherein the processor is configured to:
acquire a query condition in response to the query operation; wherein the query condition comprises a target area, target time and a target attribute;
query at least one target attribute item associated with the target attribute;
determine the target group from groups based on the at least one target attribute item, the target time and the target area; and
display the behavior statistics information of the target area.

8. The device of claim 6, wherein the processor is configured to:
query a range of each administrative region at a preset administrative division level; and
adjust geographical coordinates of the execution area in the association record to an administrative region to which the execution area belongs based on the range of each administrative region, to obtain association records corresponding to the preset administrative division level.

9. The device of claim 8, wherein the processor is configured to:
group behavior records corresponding to the same preset administrative division level to determine behavior statistics information of each group in response to multiple preset administrative division levels.

10. The device of claim 6, wherein the processor is configured to:
acquire pieces of user behavior data and pieces of user attribute data from a data source, wherein, wherein each piece of user behavior data is configured to indicate an execution user, an execution area and execution time, of a behavior; and
for each piece of user behavior data, associate the piece of user attribute data of the execution user with the corresponding execution area and execution time to obtain the association record.

11. A non-transitory computer readable storage medium stored with computer instructions, wherein, the computer instructions are configured to cause a computer to perform:
acquiring association records, wherein the association record is configured to indicate an execution area, execution time and user attribute data of an execution user, of a behavior;
splitting the association record into behavior records based on attribute items comprised in the user attribute data of the association record, wherein the behavior record is configured to indicate a mapping relationship between at least one of the attribute items and the execution area-the execution time;
grouping the behavior records to determine behavior statistics information of each group; wherein behavior records having the same attribute item, the same execution area and the same execution time belong to the same group; and
displaying behavior statistics information of a target group in response to a query operation.

12. The non-transitory computer readable storage medium of claim 11, wherein, displaying the behavior statistics information of the target group in response to the query operation, comprises:
acquiring a query condition in response to the query operation; wherein the query condition comprises a target area, target time and a target attribute;
querying at least one target attribute item associated with the target attribute;
determining the target group from groups based on the at least one target attribute item, the target time and the target area; and
displaying the behavior statistics information of the target area.

13. The non-transitory computer readable storage medium of claim 11, wherein, computer instructions are configured to cause a computer to perform:
querying a range of each administrative region at a preset administrative division level; and
adjusting geographical coordinates of the execution area in the association record to an administrative region to which the execution area belongs based on the range of each administrative region, to obtain association records corresponding to the preset administrative division level.

14. The non-transitory computer readable storage medium of claim 13, wherein, grouping the behavior records to determine the behavior statistics information of each group, comprises:
grouping behavior records corresponding to the same preset administrative division level to determine behavior statistics information of each group in response to multiple preset administrative division levels.

15. The non-transitory computer readable storage medium of claim 11, wherein, acquiring the association records, comprising:
acquiring pieces of user behavior data and pieces of user attribute data from a data source, wherein, wherein each piece of user behavior data is configured to indicate an execution user, an execution area and execution time, of a behavior; and
for each piece of user behavior data, associating the piece of user attribute data of the execution user with the corresponding execution area and execution time to obtain the association record.
